(19) United States
(12) Patent Application Publication
(10) Pub. No.: US 2024/0170203 A1
(43) Pub. Date: May 23, 2024

(54) REDUCING PARASITIC CAPACITANCE IN MEDIUM-VOLTAGE INDUCTORS

(71) Applicant: Aalborg Universitet, Aalborg Ø (DK)

(72) Inventors: Hongbo ZHAO, Aalborg Ø (DK); Stig MUNK-NIELSEN, Asaa (DK)

(21) Appl. No.: 18/551,690

(22) PCT Filed: Mar. 18, 2022
(86) PCT No.: PCT/DK2022/050053

§ 371 Date: Sep. 21, 2023

(30) Foreign Application Priority Data
Mar. 23, 2021 (DK) PA 2021 70127

(51) Int. Cl. H01F 27/34; H01F 1/153; H01F 5/06; H01F 27/00; H01F 27/32

(52) U.S. Cl. CPC H01F 27/34; H01F 1/153; H01F 5/06; H01F 27/006; H01F 27/325

(57) ABSTRACT

The present invention relates to inter alia to a conductor having at least two windings where each of the two windings preferably has layered configuration of turns, where each layer of a winding preferably is serially connected. Further, layers are typically distanced from each other, preferably by use of layer spacers, which preferably provide a void, or a number of voids, in between each layers. Conductors according to the present invention have shown to lessen, such as reducing parasitic capacitance.

### FIELD OF THE INVENTION

The present invention relates to inter alia to a conductor having at least two windings where each of the two windings preferably has layered configuration of turns, where each layer of a winding preferably is serially connected. Further, layers are typically distanced from each other, preferably by use of layer spacers, which preferably provide a void, or a number of voids, in between each layers. Conductors according to the present invention have shown to lessen, such as reducing parasitic capacitance.

### BACKGROUND OF THE INVENTION

Medium-voltage (MV) power electronics is attracting more and more attention in both academic research and industrial applications. By replacing traditional low-voltage IGBT modules with novel MV SiC MOSFETS, power converters can achieve less power loss and higher power density due to the faster switching behaviours, which are significant for, inter alia, future energy harvesting systems. However, the faster switching behaviours also pose challenges to the components in power converters since it can introduce EMI/EMC issues and cause extra losses on transistors.

Inductors are key components in such energy harvesting systems. However, the parasitic capacitances of inductors can contribute significant capacitive current during the switching transitions, especially in MV SiC MOSFETs applications, the situation become even worse due to the higher dv/dt value of the transistors, which can cause EMI/EMC issues and age the power modules. Thus, the reducing methods of parasitic capacitances are important.

Hence, an improved an improved conductor would be advantageous, and in particular a more efficient with reduced parasitic capacitance would be advantageous.

### OBJECT OF THE INVENTION

It is a further object of the present invention to provide an alternative to the prior art.

In particular, it may be seen as an object of the present invention to provide a conductor that solves the above mentioned problems of the prior art with

### SUMMARY OF THE INVENTION

Thus, the above described object and several other objects are intended to be obtained in a first aspect of the invention by providing a conductor comprising
a core comprising a first core section and a second core section, said core sections being adjacent to each other and are made from a magnetic permeable material, said two adjacent core sections are electro-magnetically connected;
a first winding on the first core section, the first winding comprising a first layered configuration of turns;
a second winding on the second core section, the second winding comprising a second layered configuration of turns;
two electrical terminals;

wherein
each layer of said layered configurations comprising turns provided by an electrical conductive wire being wound around its respective core section,
turns in adjacent layers of the first winding are electrically connected to each other in series,
turns in adjacent layers of the second winding are electrically connected to each other in series,
one of said electrical terminals is electrically connected to either
   turns of an inner most layer of the first winding, or
   turns of an outer most layer of the first winding
the other of said electrical terminals is electrically connected to either
   turns of an inner most layer of the second winding, or
   turns of an outer most layer of the second winding
the non-connected one of the turns of the inner most or outer most layer of the first winding is serially connected with the non-connected one of the turns of the outer or inner layers of the second winding that is not connected to said other of said electrical terminals. By not connected is typically meant the ends not being connected to the terminals.

Terms herein a used in manner being ordinary to a skilled person. However, some of the terms used are elaborated below.

Adjacent as used e.g. in adjacent layer is preferably used to reference layers arranged above one another (or below depending on the orientation of the view).

Layer spacer is used herein, preferably to denote an element distancing two layers of turn from each other. The layer spacers may preferably be partial spacers, which typically refers to a layer spacer having a larger length than cross section dimension, such as width the height, to a provide a void in between two layers separated by the layer spacer. It is noted that preferably a number of layer spacers are provided in between two layers.

Further embodiments are presented in the accompanying claims as well as in the following detailed description.

### BRIEF DESCRIPTION OF THE FIGURES

The present invention and in particular preferred embodiments according to the invention will now be described in more detail with regard to the accompanying figures. The figures show ways of implementing the present invention and are not to be construed as being limiting to other possible embodiments falling within the scope of the attached claim set.

FIG. 1 presents some features of a conductor according to a 1^{st} preferred embodiment; FIG. 1A illustrates the conductor in a 3-dimensional view with a part of a winding removed for clarity reasons only; FIG. 1B introduces various characteristics of conductors according to the present invention with reference to the conductor shown in FIG. 1A;

FIG. 2 introduces the schematics used herein to present various embodiments of conductors, wherein the schematics are introduced with reference to a 2^{nd} embodiment shown in FIG. 3. The proceeding FIGS. 3-13 have been drawn with the schematics introduced in this FIG. 2. Please note, that the identical windings on the other side of the core is not illustrated in the FIGS. 3-13 to avoid rendering the figures difficult to read.

FIG. 3 illustrates a 2^{nd} preferred embodiment,

FIG. 4 illustrates a 3^{rd} preferred embodiment,

FIG. 5 illustrates a 4^{th} preferred embodiment,

FIG. 6 illustrates a 5^{th} preferred embodiment,

FIG. 7 illustrates a 6^{th} preferred embodiment,

FIG. 8 illustrates a 7^{th} preferred embodiment

FIG. 9 illustrates a 8^{th} preferred embodiment,

FIG. 10 illustrates a 9^{th} preferred embodiment,

FIG. 11 illustrates a 10^{th} preferred embodiment,

FIG. 12 illustrates an 11^{th} preferred embodiment, and

FIG. 13 illustrates a 12^{th} preferred embodiment,

### DETAILED DESCRIPTION OF AN EMBODIMENT

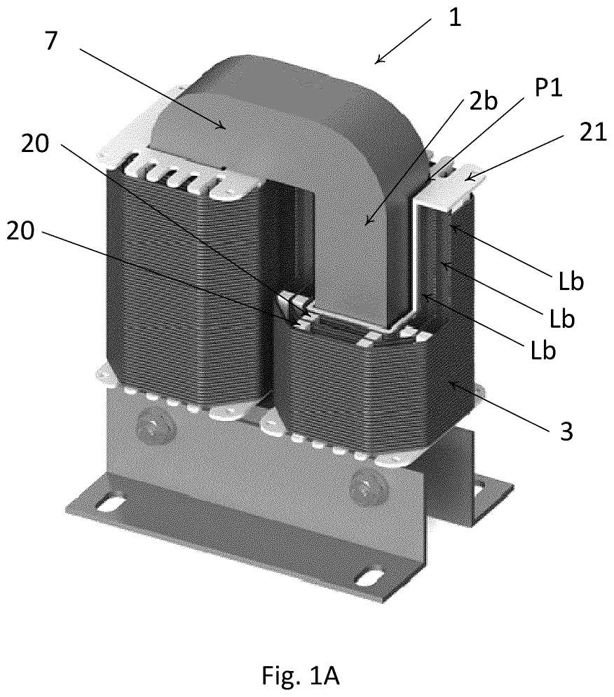

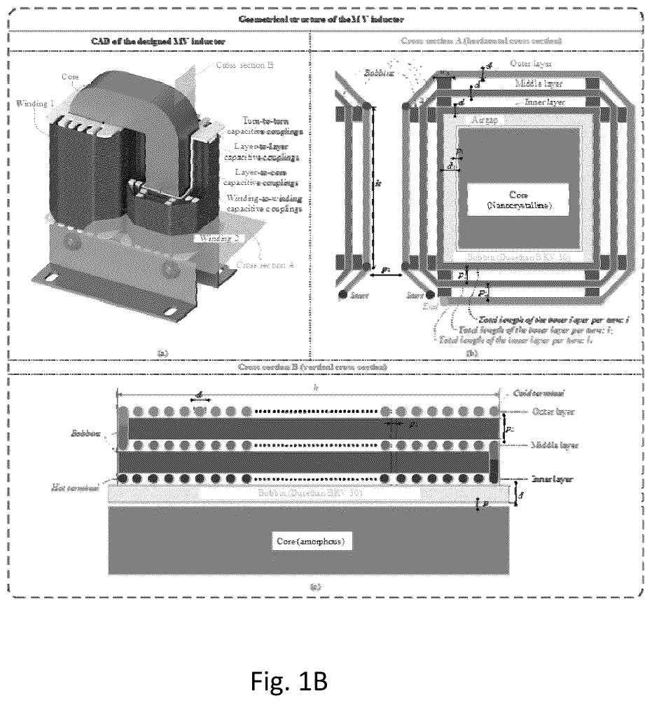

Reference is made to FIG. 1 schematically illustrating an example of a conductor according to a first preferred embodiment of the invention. FIG. 1 is split into FIG. 1A and FIG. 1B for clarity reasons only. For the conductor illustrated in FIG. 1A a section is cut-away to illustrate the interior configuration of the conductor.

As illustrated in FIG. 1a, a conductor 1 has a core 2. This core 2 comprising a first core section 2a and a second core section 2b. It is noted that the first core section 2a is hidden behind the winding. As also illustrated, the core sections 2a, 2b is arranged adjacent to each other and they are made from a magnetic permeable material. The two adjacent core sections 2a, 2b are furthermore electro-magnetically connected. As illustrated in FIG. 1A the core sections 2a, 2b form parts of a yoke being and the core section may be defined by the sections of the yoke to which windings are applied. The core sections 2a, 2b shown are straight sections, but the invention is not limited to straight sections as curvature or other shapes may be provided to the core sections 2a, 2b.

A first winding is provided on the first core section 2a and this first winding comprising a first layered configuration of turns La. In the embodiment shown in FIG. 1A three such layers La are shown. A second winding is provided on the second core section 2b and this second winding also comprising a second layered configuration of turns Lb. This second layered configuration is partially shown in FIG. 1B upper right corner. It is noted that in the embodiment of FIG. 1, the two windings are identical to each other but this invention is not limited to such identical windings.

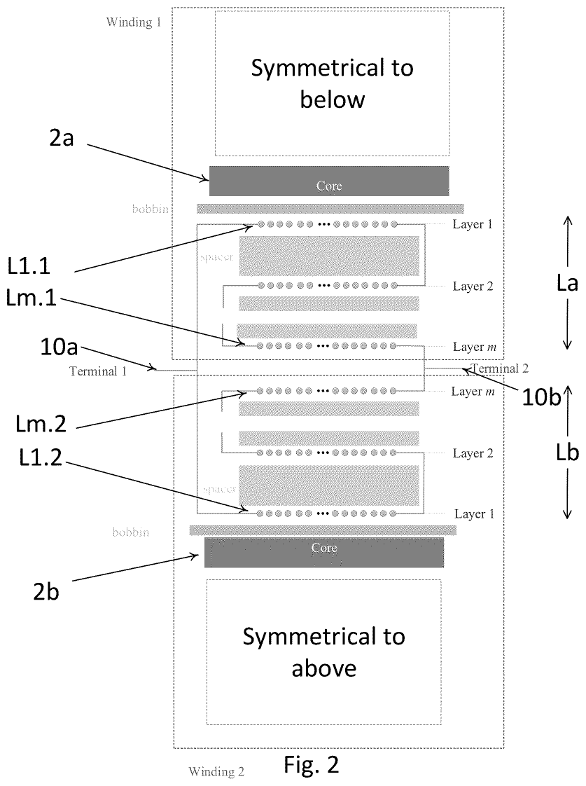

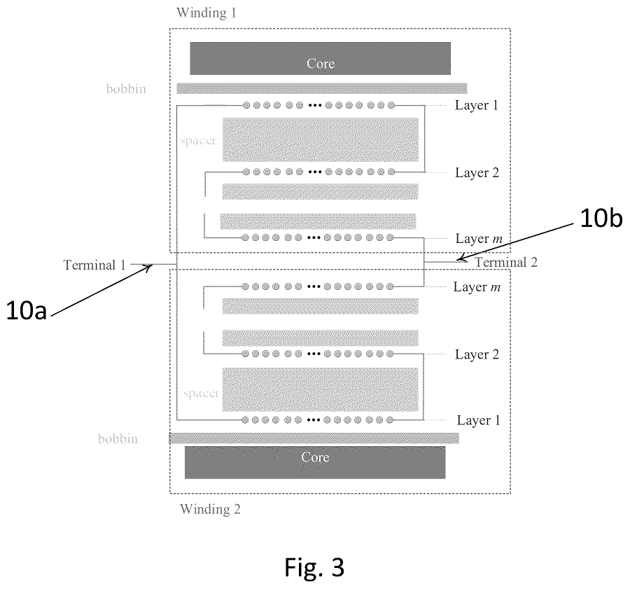

The conductor also has two electrical terminals 10a, 10b for connecting the conductor to electricity such as in a circuit. The terminals are not shown in FIG. 1 but shown e.g. in FIG. 3. The layout presented in FIG. 3-11 are presented symbolically and aligned with the lower part of FIG. 1B and as shown in FIG. 2 to render the electrical connections more identifiable.

As shown in FIG. 1, each layer 4 of said layered configurations comprising turns 3 provided by an electrical conductive wire 5 being wound around its respective core section 2a, 2b. Further, see e.g. FIG. 3, turns in adjacent layers of the first winding are electrically connected to each other in series and turns in adjacent layers of the second winding are electrically connected to each other in series. Thus, each winding may be viewed as comprising a layered configuration of turns where layers are serially connected.

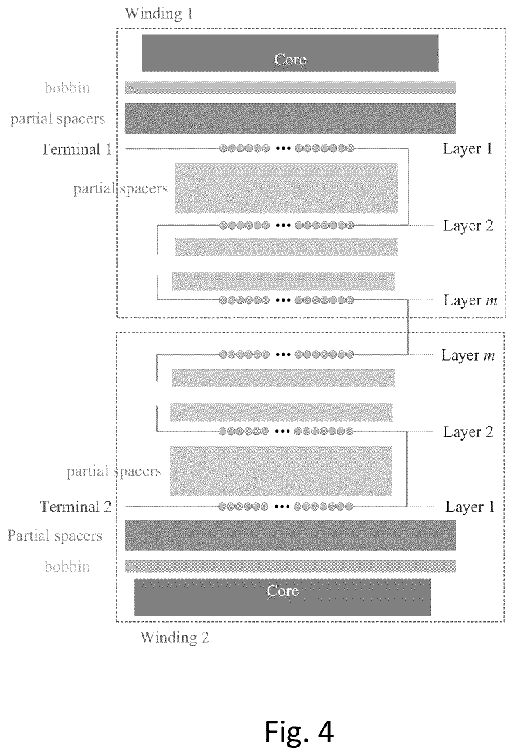

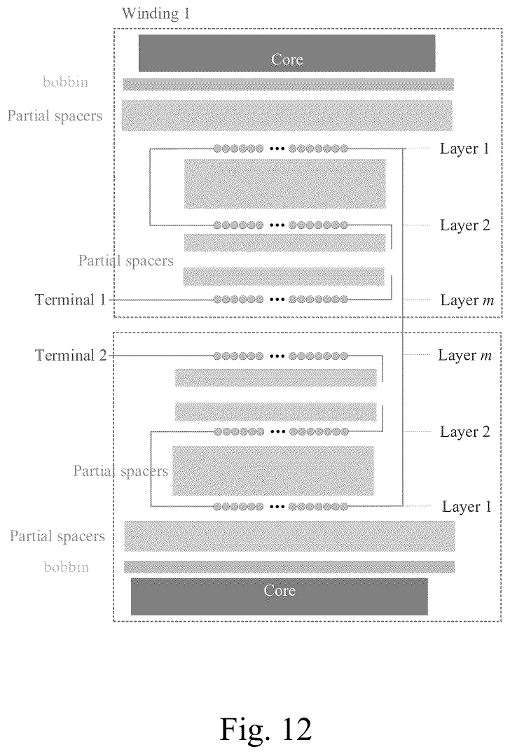

One of the electrical terminals 10a is electrically connected to either
turns of an inner most layer L1.1 of the first winding, see FIG. 4, 5, 6, 7, 8, 9, 10, 11 or
turns of an outer most layer Lm.1 of the first winding, see FIGS. 3 and 12.

Inner most here refers to the layer being closest to the core section and outermost refers to the layer being farthest away from the core section.

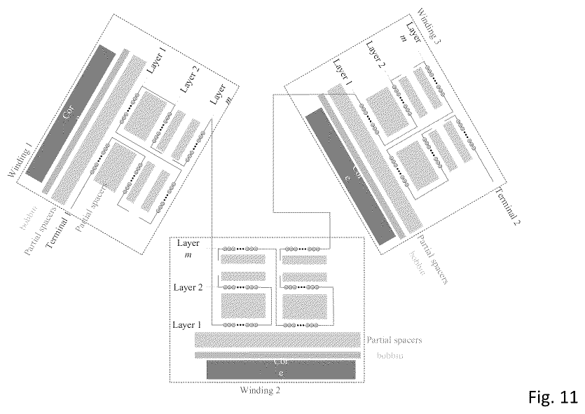

The other of said electrical terminals 10b is electrically connected to either
turns of an inner most layer L1.2 of the second winding, see FIGS. 4 and 11, or
turns of an outer most layer Lm.2 of the second winding, see FIG. 3, 5, 6, 7, 8, 9, 10, 12

To complete the circuit of the conductor 1 non-connected one of the turns of the inner most or outer most layer of the first winding is serially connected with the non-connected one of the turns of the outer or inner layers of the second winding that is not connected to said other of said electrical terminals. By non-connected one of the turns is here meant the ends of the turns that are not serially connected with another turn or one of said electrical terminals 10a, 10b. FIGS. 3-12 shows various ways of such connections.

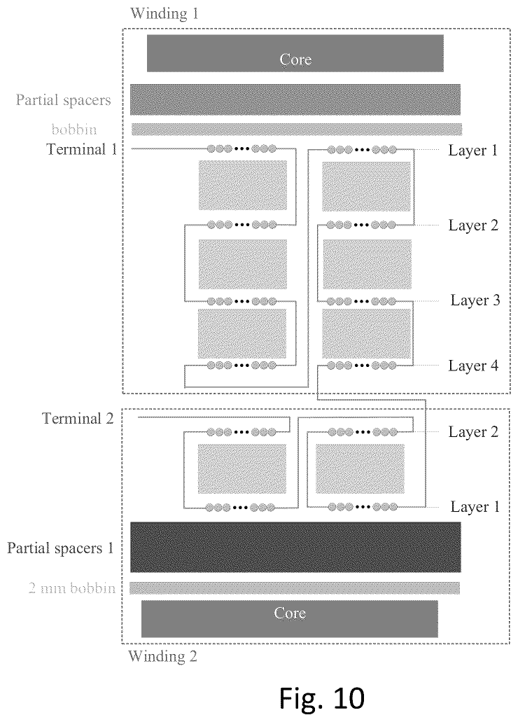

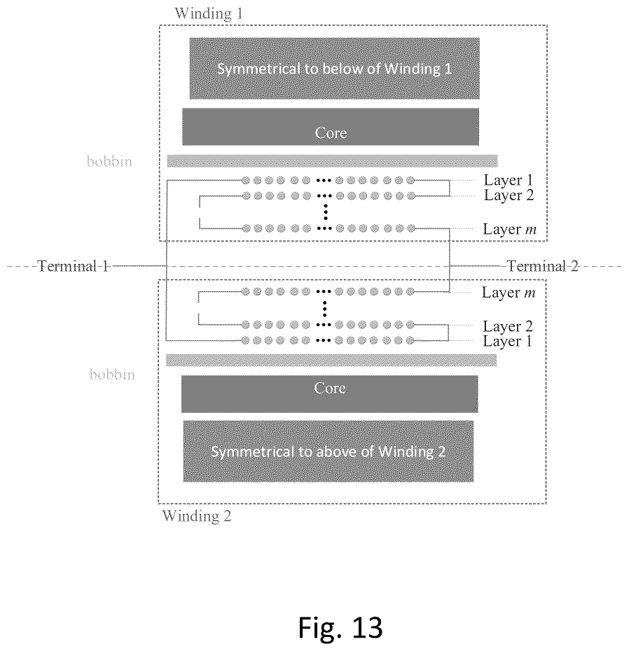

In some preferred embodiments, the number of layers in the first winding is equal to the numbers of layers in the second winding. This is illustrated in FIGS. 2, 3, 4, 5, 6, 7, 8, 9, 11, 12 and 13. Alternatively, the number of layers in the first winding is different from the numbers of windings in the second layer. One such example is shown in FIG. 10.

According to preferred embodiments, the number of turns in each layer is less than 100, such as less than 75, preferably less than 50, such as less than 30, and preferably larger than 10. The number of terms is typically selected according to a specific use of the conductor 1.

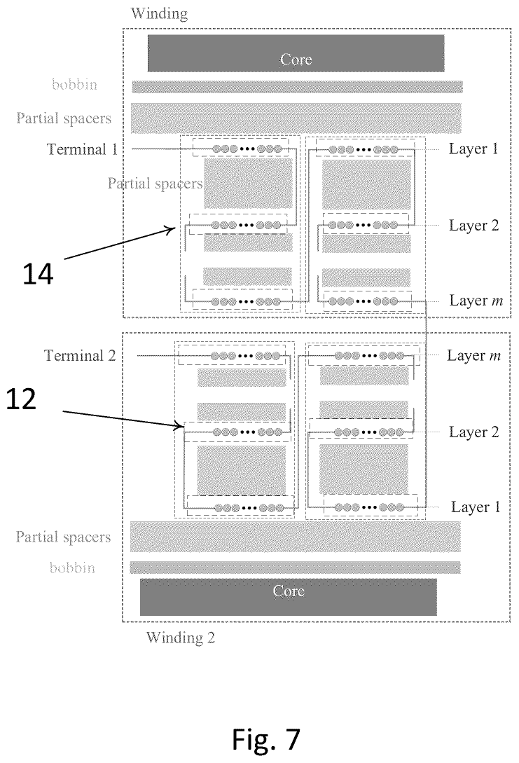

Reference is made to FIGS. 7, 8, 9, 10 and 11. In these embodiments, all of the turns of layers are separated into sections 12. A section here refers to that turns of a layer instead of forming a single coiled structure forms a number of neighbouring coiled structures. In FIG. 7, a section is indicated by a rectangular box shown with a dotted line. In such sectionalized configurations, adjacent sections are serially connected with each other, as illustrated inter alia in FIG. 7 thereby forming a serially connected section of turns.

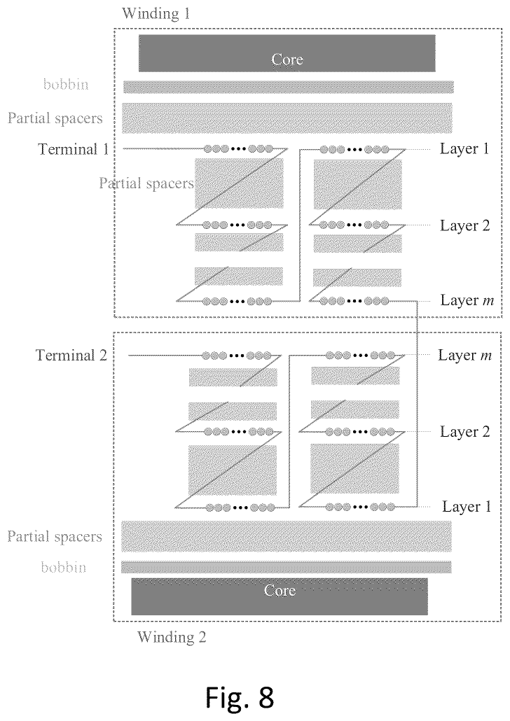

The serially connected sections placed side-by-side are serially connected with the turns on an inner most section being serially connected with a turns of an outer most section. This is shown in FIGS. 7, 8, 9, 10 and 11. It is noted that for the embodiment shown in FIG. 8, the serial connections are made so as to provide the same current flow direction in all sections 12, whereas for FIGS. 7, 9, 10 and 11 the serial connections are made to change the voltage difference between two adjacent layers. These different serial connections may be combined in the various embodiments.

A typical number of section 12 is two, three, four, five or even more. Thus, although the figures only details embodiments with two or three sections, more sections may be provided. In preferred embodiments, each of the sections 12 has substantially equal turns.

As presented in all the figures, although perhaps most prominent shown in FIG. 1A, turns of adjacent layers are spaced apart by layer spacers 20 which are inter alia used to reduce capacitive couplings between layers. The layer spacers 20 are also found to provide a structural integrity of the conductor. However, the invention is not limited to conductors being provided with layer spacers 20, but it has been found that use of such layer spacers 20 further decrease the parasitic capacitance of a conductor. Accordingly, the thicker the layer spacers 20 are, the lesser parasitic capacitance may be obtained.

The layer spacers 20 each has a thickness of defining the distance between adjacent layers and a width defined in the direction of the turns so as to define an air gap in-between two layers. The thickness of the air gap is typically chosen to be less than 10.0 mm, such as less than 8.0 mm, preferably less than 6.0 mm, such as less than 5.0 mm, preferably less than 4.0 mm, and larger than 2.0 mm.

Further, turns of the inner most layer L1.1 of the first winding and turns of the inner most layer L1.2 of the second winding each is spaced apart from the their corresponding core sections 2a, 2b by a bobbin 21 so as to form an air gap P1 between an inner surface of the bobbins 21 and an outer surface of the core sections 2a, 2b. Two such bobbins 21, one for each core section are illustrated in FIG. 1A. In the embodiment shown, the bobbins 21 comprising a tubular section inside which the core section extent and at the extremities of the bobbins 21 outwardly protruding elements are provided so that the bobbins each form an open receptacle for receiving a winding and delimiting movement of the winding in a direction aligned with the longitudinal extension of the bobbin 21.

The bobbins 21 are in preferred embodiments, dimensioned relatively to the dimension of the core sections 2a, 2b so as to provide the air gap P1 of less than 2.0 mm, such as less than 1.5 mm, preferably less than 1.0 mm, such as less that 0.75 mm, preferably less than 0.5 mm and larger than 0.25 mm.

Preferably, layer spacers 20 and the bobbins 21 are made from polypropylene, polytetrafluoroethylene, polyethylene terephthalate, polyimide or combinations thereof.

As the conductor is to be used, inter alia, in electrical circuits the electrical conductive wire 5 is made from an electrical conductive material, such as copper or a composition comprising copper. To avoid electrical contact between neighbouring and adjacent turns, the conductive wire may be provided with an outer electrical isolation typically made from e.g. modified polyester or polyesterimide, overcoated with polyamide-imide. The diameter of the electrical conductive wire 5 without the electrical isolation is selected in accordance with specific desire as to electrical characteristic, and is typically less than 5.0 mm, such as less than 4.0 mm, preferably less than 3.0 mm, such as less than 2.0 mm, preferably less than 1.0 mm, and larger than 0.5 mm.

The core is to allow conductance of a magnetic field and is made from a material providing such conductance. In preferred embodiments, the 2 is made from an amorphous material, preferably an alloy with a non crystalline structure produced by ultra-rapid quenching, such as about 1 million ° C. per second of molten alloy, MnZn ferrite core, Silicon steel, such as electrical steel, lamination steel, silicon electrical steel, silicon steel, relay steel, transformer steel, an iron alloy tailored to produce specific magnetic properties, and/or nanocrystalline material is a polycrystalline material with a crystallite size of only a few nanometers, such as nanometers, but other materials may be used.

In certain preferred embodiments like the one shown in FIG. 1, the core 2 is in the form of a yoke. Such a yoke may be characterised as comprising a polygonal annulus with an opening which in the embodiment shown in FIG. 1 is a rectangular annulus where outer corners are rounded. In particular preferred embodiments, the first core section 2a and the second core section 2b are straight parts each having a uniform cross section, preferably rectangular, around which parts the windings are provided. Preferably, the first core section 2a and the second core section 2b extent in parallel with a distance in between, as illustrated in FIG. 1, and two electro-magnetically connectors 7 are arranged for electro-magnetically connecting the first core section with the second core section 2a, 2b so as to form a closed magnetic flux yoke. It is noted that while the various sections of the core/yoke are disclosed separately, they may be formed integral with each other or as elements pieced together to form the core/yoke.

In preferred embodiments, the core is grounded and in other the core is floating.

Non-Limiting Examples

Non-limiting examples on numbers for the various elements of the conductor is presented in the following table and with reference to FIG. 1B.

TABLE I
Illustrative parameters of a MV inductor
according to a preferred embodiment:

| Description | Symbol | Value | |
|---|---|---|---|
| Diameter of the cable | d₀ | 1.4 | mm |
| Length of the air gap between the bobbin and core | p₁ | 0.75 | mm |
| Thickness of the bobbins between the inner layer | d₁ | 2 | mm |
| and core | | | |
| Length of the air gap between two adjacent layers | p₂ | 5.7 | mm |
| Average length of the air gap between two turns | p₃ | 0.45 | mm |
| in the same layer | | | |
| Height of the windings | h | 11.9 | cm |
| Width of the spacers between two adjacent layers | w_{b} | 4.8 | mm |
| Length of the outer layer per turn | l₁ | 24.7 | cm |
| Length of the middle layer per turn | l₂ | 22.2 | cm |
| Length of the inner layer per turn | l₃ | 19.7 | cm |
| Average length of per turn for three layers | l | 22.2 | cm |
| Average length of the air gap between the two | p₄ | 3 | mm |
| windings | | | |
| Number of turns of per layers | n | 63 | |
| Number of layers | m | 3 | |
| Number of the winding | w | 2 | |
| Total inductance | L | 30 | mH |
| Equivalent inductance per turn | L₁ | 0.079 | mH |

The following table II provides illustrative numbers for electrical characteristics of some of the conductors shown in the figures:

In the inventors' endeavour to reduce parasitic capacitances of conductors, the inventors have proposed some new solutions for inductors, such as MV conductors. In the proposed design guides, the inventors suggest to not only optimize the layout in each winding, but also optimize the electrical arrangements of the multiple windings.

In preferred embodiments, the design guides proposed by the inventors may be summarized by the following Items:
1) The multiple windings of the MV inductor may advantageously be electrically connected in series.
2) In each winding, the layout of windings may advantageously be separated into multiple sections, for reducing the electrical field energy stored within the winding.
3) In order to reduce the parasitic capacitance between the terminal and core, the layout in each winding may advantageously be arranged for storing less electrical-field energy between the inner layer of winding and core. The voltage potential difference between the inner layer of each winding and core is less with the proposed design guide.
4) Between two adjacent layers, partial spacers, also referred herein to as “layer spacer”, may advantageously be used for reducing the capacitive couplings. The thickness of the spacers might be varied in different applications.
5) Between the inner layer of winding and core, partial spacers may advantageously be used for reducing the capacitive couplings. Such a partial spacer may be provided as a bobbin as disclosed herein. The thickness of the spacers might be varied in different applications.
6) The width of partial spacers could advantageously be as small as possible, for preferably only providing the mechanical support to the windings, thus the capacitive couplings between the two planes are mostly reduced. Besides, the material of partial spacers should be selected with low permittivity, e.g. polypropylene, polytetrafluoroethylene, mylar (biaxially-oriented polyethylene terephthalate), polyimide and similar materials.
7) Both symmetrical and asymmetrical winding (see FIG. 10) arrangements are proposed for different applications in practices.
8) In each layer of windings, the turns may advantageously be arranged closed to each other for avoiding extra couplings between non-adjacent layers.

It is to be emphasized that not all Items 1) to 8) not have to be applied at the same time, as a sub-set of the items may be applied individually.

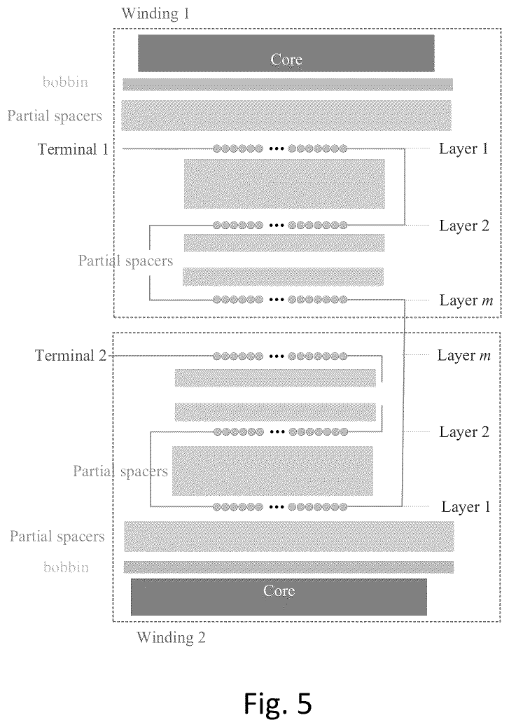

Several embodiments are presented in FIGS. 1-13 which illustrate Items of the proposed design guide. The schematic of Embodiment 3 is shown in FIG. 4. Items 1), 4), 5), 6) and 8) can be found in FIG. 4. The turns in the same layer are placed very closed to the neighbour turns, for avoiding possible air gaps between two neighbour turns. Besides, the partial spacers 20 are used between two adjacent layers, as well as between the inner layer and core, where in FIG. 4 the space between two adjacent layers is only partially filled a little by the partial spacers. The design of Embodiment 3 is further improved by using the other proposed ideas, which is shown in FIG. 5 as Embodiment 4. In Embodiment 4, Items 1), 4), 5), 6) and 8) are still used. However, in order to further reduce the capacitive couplings between the inner layer and core, Item 3) is used in Embodiment 4.

According to FIG. 5, the winding layout in Winding 2 is different compared to the winding layout in Winding 2 in FIG. 4, where the terminal 2 is not ended at the inner layer of Winding 2, but at the outer layer. The benefit of the winding layout in Embodiment 4 is, the voltage potential difference between the inner layer of Winding 2 and core is smaller than it in Embodiment 3, where the physical size of the inner layer in these two embodiments is still the same. Thus, the capacitive coupling between the inner layer and core of Embodiment 4 is smaller than Embodiment 3 since less electrical-field energy is stored in between.

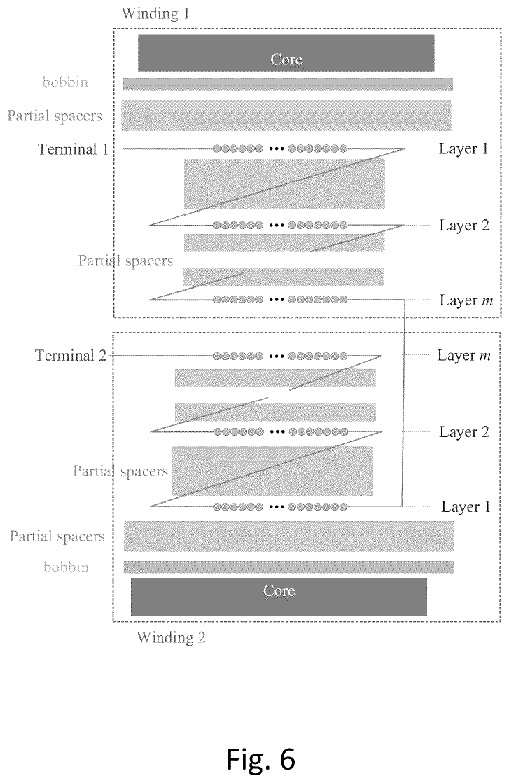

In order to further reduce the electrical-field energy stored within the winding, Embodiment 5 is introduced by optimizing the winding layout of the connections between two adjacent windings, where the schematic is shown in FIG. 6.

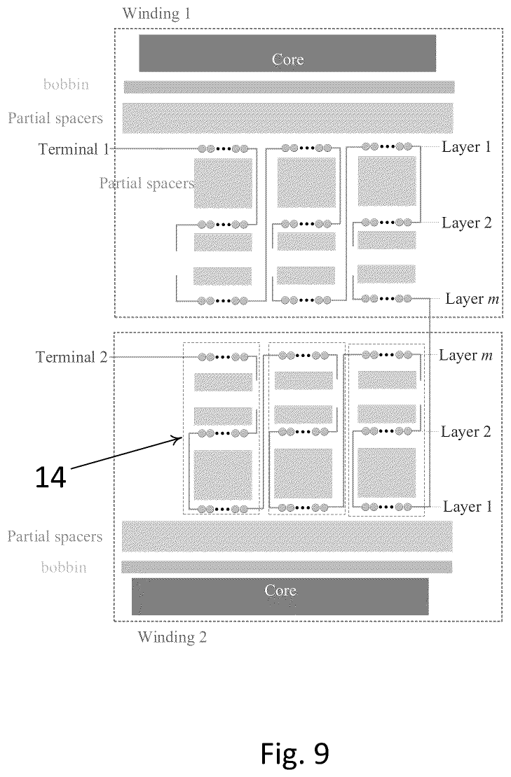

Another method to reduce the electrical-field energy stored within the winding is to apply Item 2), to separate the windings into multiple sections 12, as shown in Embodiment 6 in FIG. 7. Embodiment 5 and Embodiment 6 are able to be combined for further reducing the parasitic capacitances, which is given as Embodiment 7 and shown in FIG. 8. Embodiment 8 shown in FIG. 9 shares some of the features presented in the embodiment shown in FIG. 7, however, in FIG. 9, each winding has been sectionalized with three winding sections 14, whereas each winding in FIG. 7 has been sectionalized with two winding sections 14. The sectionalisation is illustrated with dotted lines

Embodiment 3-8 are all based on a symmetrical winding, where the number of layers in two windings are the same as m. However, except from Embodiment 3, embodiments 4-8 result in unidentical parasitic capacitances C_{Terminal1-core} and C_{Terminal2-core}.

Thus, the inventors also propose the multi-winding inductor with asymmetrical windings, which is shown as Embodiment 9 in FIG. 10. In order to clearly explain the concept, it is assumed that there are four layers in Winding 1, and two layers in Winding 2. With changing the thickness of “Partial spacers 1”, the equivalent capacitances C_{Terminal1-core} and C_{Terminal2-core} can be identical. This characteristic is convenient in practice.

Embodiment 3 to Embodiment 9 are only illustrated in MV inductor with two windings. It is also able to apply the Items above into an inductor with more than two windings. Embodiment 10 shown in FIG. 11 gives an example to extend the Items into the MV inductor with three windings. The number of sections in each winding is not limited to two. It is able to use a larger number of sections in practice, which is dependent by the geometrical size of core as well as the rated current level of windings. In Embodiment 8, an example of the two-winding inductor with three sections in each winding is given as FIG. 9.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

List of reference symbols used
1 Conductor
2 Core
2a, 2b Core section
3 Turns
4 Layer
5 Electrical conductive wire
6 Winding
7 Electro-magnetically connector
10a, 10b Electrical terminals
12 Section
14 Winding section
20 Layer spacer
21 Bobbin
La First layered configuration of turns
Lb Second layered configuration of turns
L1.1 Inner most layer of the first winding
Lm.1 Outer most layer of the first winding
L1.2 Inner most layer of the second winding
Lm.2 Outermost layer of the second winding
P1, P Air gap

1. A conductor comprising
a core comprising a first core section and a second core section, said core sections being adjacent to each other and are made from a magnetic permeable material, said two adjacent core sections are electro-magnetically connected;
a first winding on the first core section, the first winding comprising a first layered configuration of turns;
a second winding on the second core section, the second winding comprising a second layered configuration of turns;
two electrical terminals;
wherein
each layer of said layered configurations comprising turns provided by an electrical conductive wire being wound around its respective core section,
turns in adjacent layers of the first winding are electrically connected to each other in series,
turns in adjacent layers of the second winding are electrically connected to each other in series,
one of said electrical terminals is electrically connected to either
turns of an inner most layer of the first winding, or
turns of an outer most layer of the first winding
the other of said electrical terminals is electrically connected to either
turns of an inner most layer of the second winding, or
turns of an outer most layer of the second winding
the non-connected one of the turns of the inner most or outer most layer of the first winding is serially connected with the non-connected one of the turns of the outer or inner layers of the second winding that is not connected to said other of said electrical terminals.

2. A conductor according to claim 1, wherein the number of layers in the first winding is equal to the numbers of layers in the second winding.

3. A conductor according to claim 1, wherein the number of layers in the first winding is different from the numbers of windings in the second layer.

4. A conductor according to claim 1, wherein number of turns in each layer is less than 100, such as less than 75, preferably less than 50, such as less than 30, and preferably larger than 10.

5. A conductor according to claim 1 any one of the preceding claims, wherein
one or more, such as all of the turns of a layer are separated into sections,
adjacent sections are serially connected, and
said serially connected sections placed side-by-side are serially connected with the turns on an inner most section being serially connected with an turns of an outer most section.

6. A conductor according to claim 5, wherein the number of sections is two, three, four, five or even more.

7. A conductor according to claim 1, wherein each of the sections has substantially equal turns.

8. A conductor according to claim 1 wherein turns of adjacent layers are spaced apart by layer spacers.

9. A conductor according to claim 8, where the layer spacers each has a thickness of defining the distance between adjacent layers and a width defined in the direction of the turns so as to define an air gap in-between two layers with a thickness less than 10.0 mm, such as less than 8.0 mm, preferably less than 6.0 mm, such as less that 5.0 mm, preferably less than 4.0 mm, and larger than 2.0 mm.

10. A conductor according to claim 1, where the turns of the inner most layer of the first winding and turns of the inner most layer of the second winding each is spaced apart from the their corresponding core sections by a bobbin so as to form an airgap between an inner surface of the bobbins and an outer surface of the core sections.

11. A conductor according to claim 10, wherein the bobbins are dimensioned relatively to the dimension of the core sections so as to provide the air gap of less than 2.0 mm, such as less than 1.5 mm, preferably less than 1.0 mm, such as less that 0.75 mm, preferably less than 0.5 mm and larger than 0.25 mm.

12. A conductor according to claim 11, wherein the layer spacers and/or when dependent on claim 10 the bobbins are made from polypropylene, polytetrafluoroethylene, polyethylene terephthalate, polyimide or combinations thereof.

13. A conductor according to claim 1, wherein the electrical conductive wire is made from copper or a composition comprising copper and wherein the conductive wire is provided with an outer electrical isolation made from e.g. modified polyester or polyesterimide, overcoated with polyamide-imide, wherein the diameter of the electrical conductive wire without the electrical isolation is less than 5.0 mm, such as less than 4.0 mm, preferably less than 3.0 mm, such as less than 2.0 mm, preferably less than 1.0 mm, and larger than 0.5 mm.

14. A conductor according to claim 1, wherein the core is made from an amorphous material, preferably an alloy with a non crystalline structure produced by ultra-rapid quenching, such as about 1 million ° C. per second of molten alloy, MnZn ferrite core, Silicon steel, such as electrical steel, lamination steel, silicon electrical steel, silicon steel, relay steel, transformer steel, an iron alloy tailored to produce specific magnetic properties, and/or nanocrystalline material is a polycrystalline material with a crystallite size of only a few nanometers, such as 10 nanometers

15. A conductor according to claim 1, wherein the core is a yoke and wherein
the first core section and the second core section comprising straight parts each having a uniform cross section, preferably rectangular, around which parts the windings are provided,
the first core section and the second core section extent in parallel with a distance inbetween, and
two electro-magnetically connectors are arranged for electro-magnetically connecting the first core section with the second core section so as to form a closed magnetic flux yoke.

16. A conductor according to claim 1, wherein the core is grounded or floating.
